(19) United States
(12) Patent Application Publication
(10) Pub. No.: US 2022/0322863 A1
(43) Pub. Date: Oct. 13, 2022

(54) Disposable curtain system and preassembled wheels, extension and lockable quick-release system therefor and method

(71) Applicant: Bannack Medical LLC, Gilbert, AZ (US)

(72) Inventors: Arlen Olsen, Clifton Park, NY (US); Joel Price, Germantown, MD (US); Laurinda Olsen, Clifton Park, NY (US); Joshua Olsen, Logan (NY)

(21) Appl. No.: 17/225,321

(22) Filed: Apr. 8, 2021

(51) Int. Cl. A47H 13/04; A47H 1/04; A47H 15/02

(52) U.S. Cl. CPC A47H 13/04; A47H 1/04; A47H 15/02; A61G 12/00

(57) ABSTRACT

Disclosed is a disposable curtain system, a hook attachment and a preassembled quick-release system therefor and method. The disposable curtain system is for use in health care facilities to maintain a clean environment. The disposable curtain system includes: a curtain attachment system comprising: a wheel system, the wheel system having: a first end with rollers for use with a track; and a second end with an attachment, the attachment having a first hole, opening or bore therein; an extension, attached to the wheel system, the extension having: first end with a quick release for a curtain attached thereto; and a second end with corresponding hole, opening or bore therein and a corresponding attachment for going through the first hole, opening or bore in the attachment, wherein the corresponding attachment is a closed hole, opening or bore.

### CROSS-REFERENCE TO RELATED APPLICATIONS

This application is related to U.S. application Ser. No. 17/011,571 filed on Sep. 3, 2020; U.S. application Ser. No. 17/004,625 filed on Aug. 27, 2020; and U.S. application Ser. No. 16/933,545 filed on Jul. 20, 2020 which all disclosures are hereby incorporated by reference in their entireties.

### FIELD OF THE INVENTION

Disclosed is a disposable curtain system, components therefor and method. In particular, is a disposable curtain system having preassembled wheels, extension and lockable quick-release system, most often, for use in health care facilities to maintain a clean environment.

### BACKGROUND

Health care facilities, such as hospitals, nursing homes, doctor's offices, urgent care facilities, and long-term care facilities are becoming more and more concerned with infectious diseases being present. The COVID-19 pandemic is one major infectious disease that has brought attention to the public by the media to the concerns of cleanliness of health care facilities and other public spaces. In addition to COVID-19 are other infections diseases such as bacterial infection diseases like Anthrax, bacterial botulism, brucellosis, cholera, diphtheria, Lyme's disease, tuberculosis; fungal infectious diseases like aspergillosis, blastomycosis, candidiasis, cryptococcosis, histoplasmosis; parasitic infectious diseases like ascariasis, cryptosporidiosis, giardiasis, malaria, scabies; prion infectious diseases like Alper's syndrome, Creutzfeldt-Jakob disease, kuru; and viral infectious diseases like COVID-19, AIDS, chickenpox, Common Cold, Ebola, herpes, Influenza, mumps, rabies, rubella, viral meningitis, yellow fever and many more.

One location in the hospital that has a concern with infectious disease are the privacy curtains in locations such as the Emergency Room (“ER”) and Intensive Care Unit (“ICU”). Medical personnel will take many precautions such as washing hands, wearing gloves and wearing personal protection equipment. However, while wearing gloves they will grab the curtains with their gloved hands which may leave infectious diseases on the curtains due to contact with bodily fluids such as blood, saliva, urine, mucous, phlegm, etc. In addition, patients which are surrounded by the curtain systems will cough, sneeze or perform other bodily functions which expel airborne liquids into the air surrounding their bed or private space.

Curtain systems for hospitals are generally attached to the ceiling. The curtains systems have a track which is affixed to the ceiling. Within the track are rollers with hooks. The curtains attach to the hooks.

A difficulty with this system is that the tracks and hooks are attached to ceilings that can be from 7 to 12 feet above the ceiling. This requires maintenance personnel at the hospital to use ladders or other stools to replace the curtains.

A further difficulty is when replacing the curtain system, the roller hooks in the track many times need to be crimped causing repetitive problems with the installer having problems with muscles and tendons due to repetitive installation of the curtains on the hooks.

Another difficulty is that the most curtain systems are not easily and quickly disassembled and require personnel to remove the curtains, one hook at a time.

Another difficulty is that the track and rollers come separately or are already existing and thus when installing the extension and quick release, extensive work needs to be done to attach the system in-situ while the installer is on a ladder.

In the past, curtain systems required keyways such as shown in U.S. Pat. No. 9,585,508.

### SUMMARY

Disclosed is a disposable curtain system, attachment therefor and method.

An advantage is the ability to quickly attach a disposable curtain system to hooks on a pre-existing or installed curtain system.

Another advantage is once installed, there will be no or minimal need for health care personnel to climb on ladders or stools to reach the hooks for replacement of the curtains.

Another advantage is that health care personnel will not need to crimp the hooks.

Another advantage is removal and disposal and or recycling of the curtains on a regular basis.

Another advantage is that the quick release and lock system may be usable by an installer/disassembler at approximately a height of 6-7 feet for easy installation and removal, it will have disposable curtain attachments that quickly attach and detach with a single or small number or movements during installation and disassembly.

An advantage is that the disclosed embodiments do not require a keyway or turning mechanism for installation of disposable hospital curtains as in the relevant art.

An advantage is that the disposable curtain system may be held in a receiver or cradle by gravity and it does not require a latch or lock mechanism.

An advantage is that the disposable curtain system has a quick-release having a lockable quick release with a housing with an opening therein into which a head may be inserted and dropped down. The motion makes accidental removal of the head from the opening and cradle or receiver more difficult.

Another advantage is that the head is inserted into the quick-release housing in a first direction which is perpendicular or angular to the direction that the curtains are pulled, thus alleviating accidental removal of the curtain from the curtain system.

Another advantage is the current system makes it possible to remove the end cap from a track and install the wheel system with the extension and quick-release all at once. In the case of replacement, the old rollers merely need to be removed.

Another advantage is that there is no need to deal with the hooks that would normally need to be crimped during installation.

Accordingly, various embodiments of the invention disclosed include: A curtain attachment system comprising: a wheel system, said wheel system having: a first end with rollers for use with a track; and a second end with a first attachment or portion having a first hole, opening or bore therein; a curtain quick release; an extension, said extension having: first end attached to the curtain quick release system; and a second end with a hole, opening or bore therein corresponding to said first hole, opening or bore.

Accordingly, various embodiments of the invention disclosed include: A method for attaching a disposable curtain system comprising: providing a track; preassembling a wheel system together with an extension having a curtain quick-release system, said wheel system having: a first end with rollers for use with a track; and a second end with an attachment, said attachment having a first hole, opening or bore therein; said extension, attached to the wheel system, said extension having: first end with a quick release for a curtain attached thereto; and a second end with corresponding hole, opening or bore therein and a corresponding attachment for going through the first hole, opening or bore in the attachment, wherein said corresponding attachment is a closed hole, opening or bore; inserting the pre-assembled wheel system onto the track; and attaching the curtain using a curtain attachment to the quick-release.

Accordingly, various embodiments of the invention disclosed include: A curtain retainer system for use with a curtain having a plurality of curtain attachments extending from the curtain, said curtain attachments each having a neck and a head, wherein said curtain attachments for attachment to a quick-release system, said curtain retainer comprising: a plurality of grips; and a plurality of holders, wherein each holder for engaging and holding the necks of the curtain attachments while the curtain attachments are inserted into the quick release.

### BRIEF DESCRIPTION

Some of the embodiments will be described in detail, with reference to the following figures, wherein like designations denote like members, wherein:

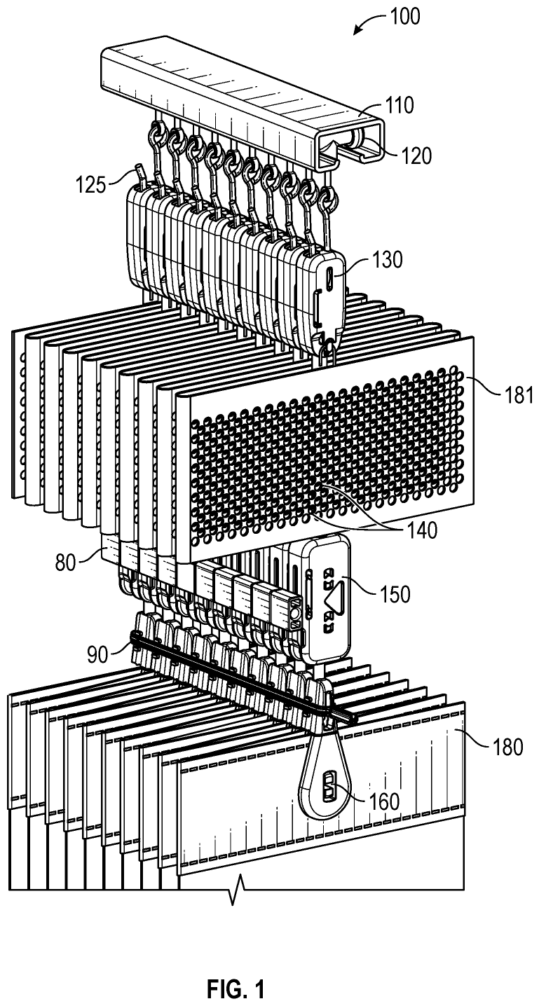

FIG. 1 shows a curtain system according to an embodiment of the invention;

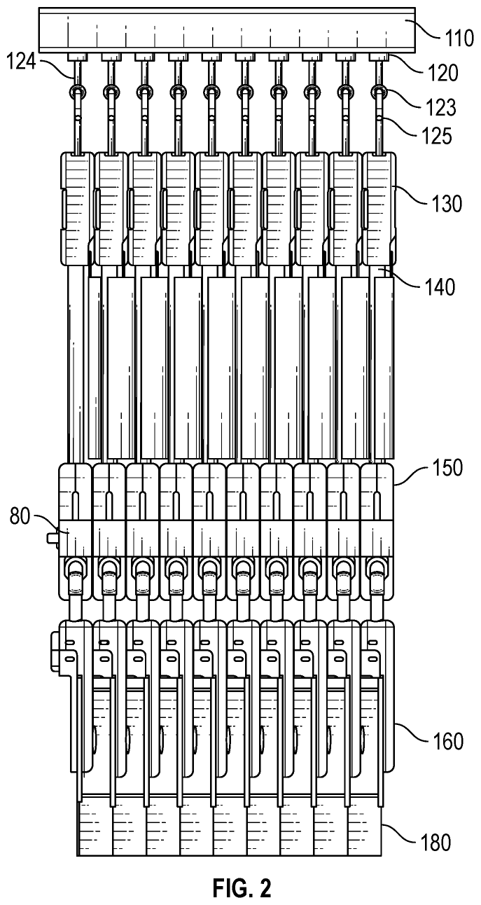

FIG. 2 shows a front view of a curtain system according to an embodiment of the invention;

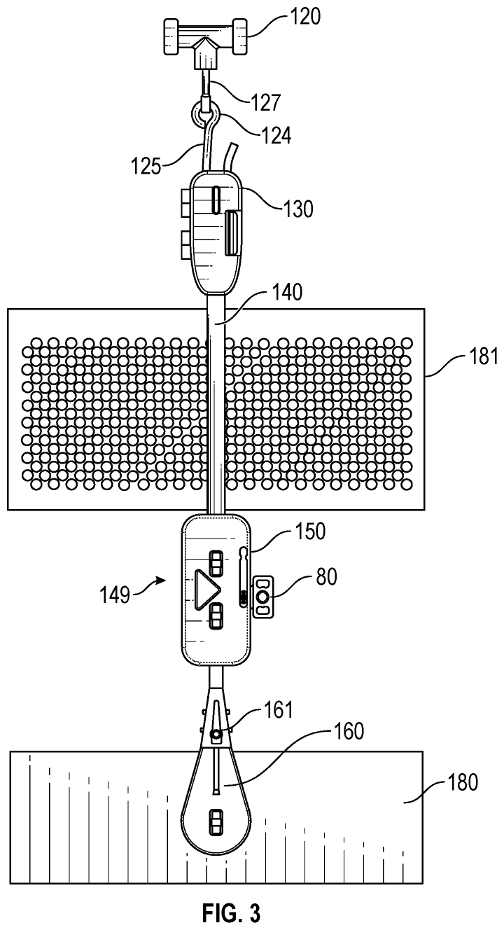

FIG. 3 shows a side view of a curtain system according to an embodiment of the invention;

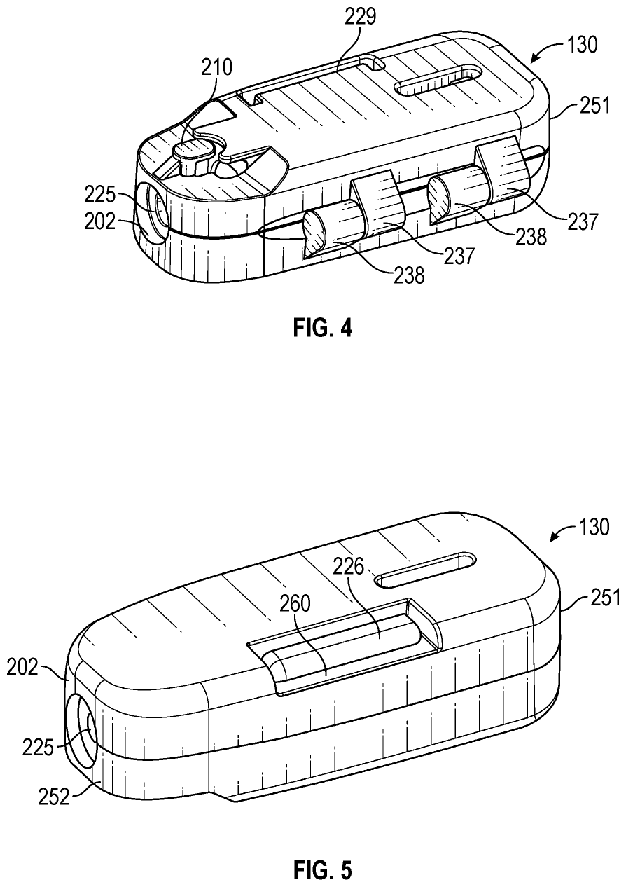

FIG. 4 shows a bottom and side perspective view of a hook attachment according to an embodiment of the invention;

FIG. 5 shows a top and side perspective view of a hook attachment according to an embodiment of the invention;

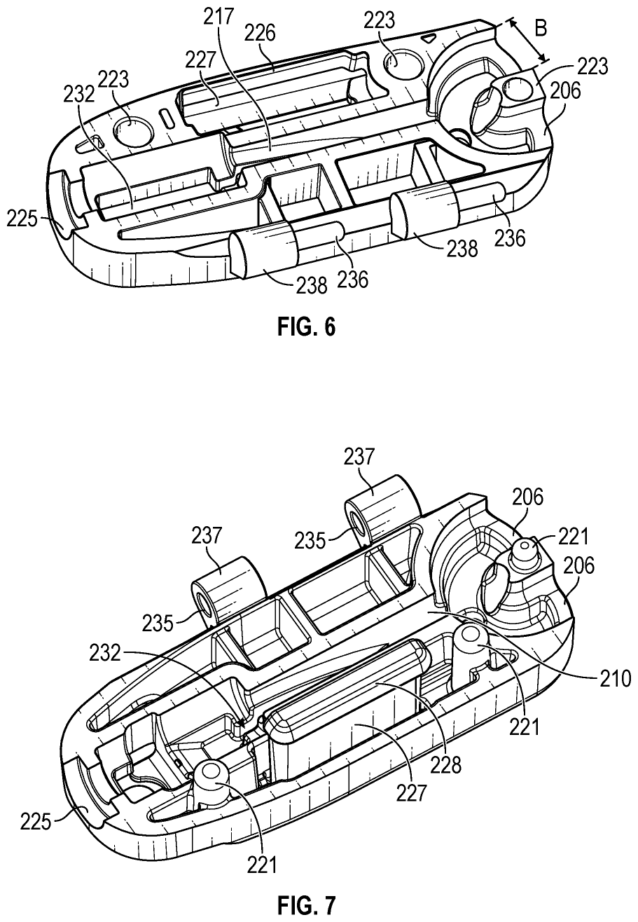

FIG. 6 shows a first side of the inside of a hook attachment according to an embodiment of the invention;

FIG. 7 shows a second side of the inside of a hook attachment according to an embodiment of the invention;

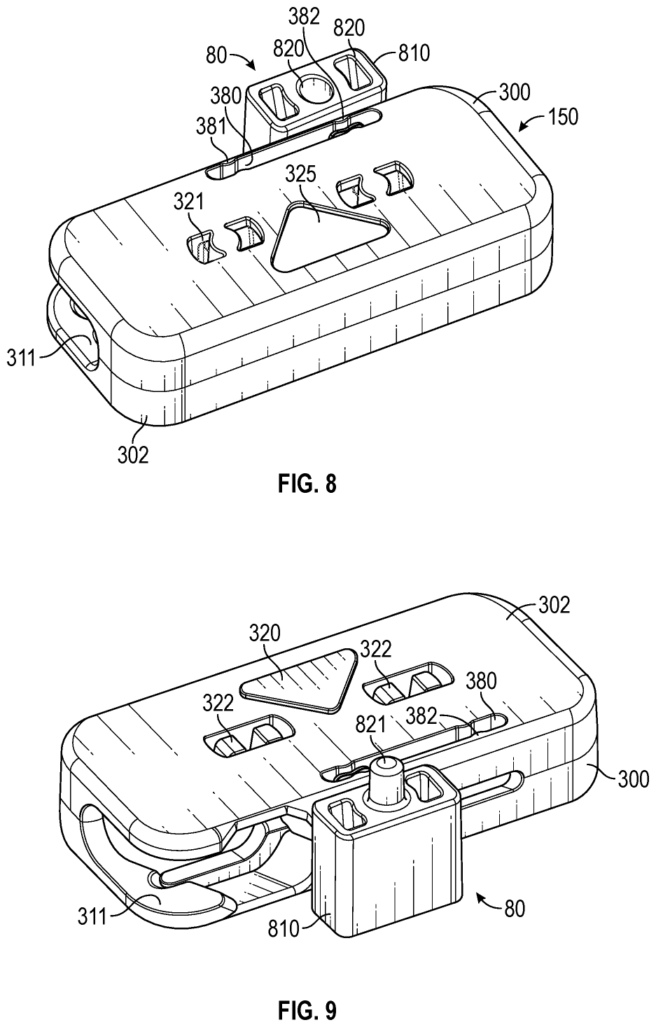

FIG. 8 shows a first perspective view of a quick release system according to an embodiment of the invention;

FIG. 9 shows a second perspective view of a quick release system according to an embodiment of the invention;

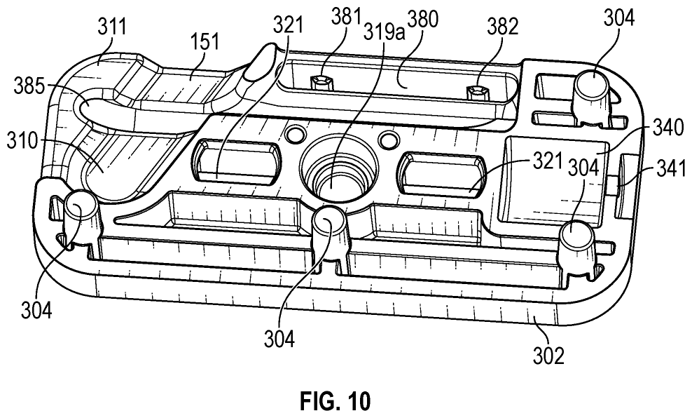

FIG. 10 shows a first side of the inside of a quick release system according to an embodiment of the invention;

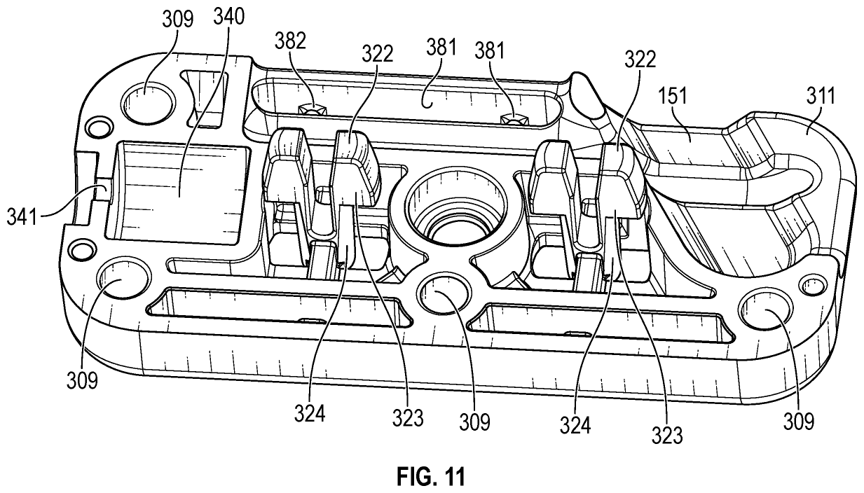

FIG. 11 shows a second side of the inside of a quick release system according to an embodiment of the invention;

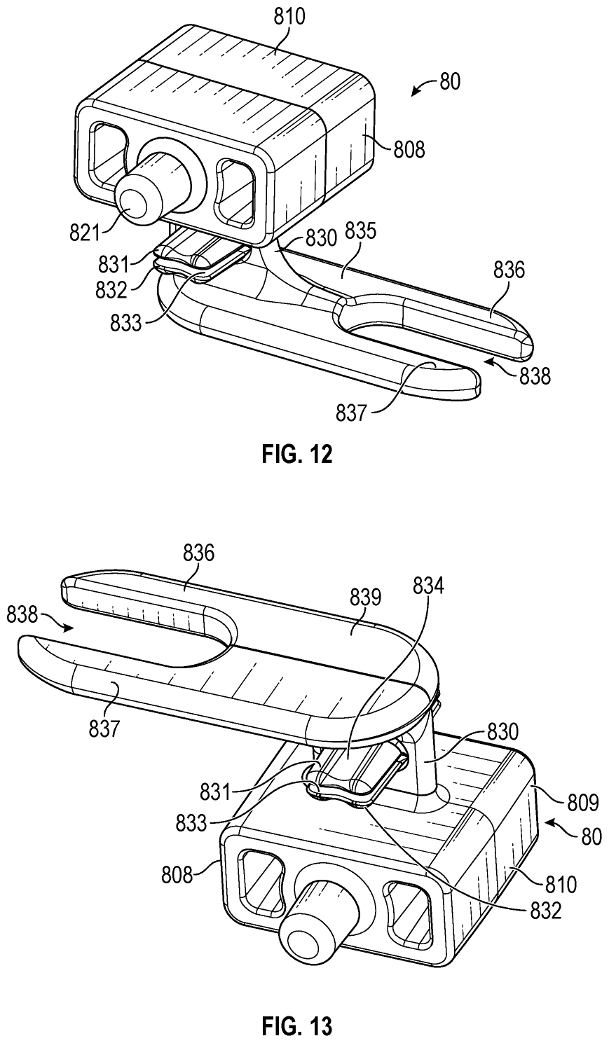

FIG. 12 shows a perspective view of a sliding lock used in a locking mechanism according to an embodiment of the invention;

FIG. 13 shows another perspective view of a sliding lock used in a locking mechanism according to an embodiment of the invention;

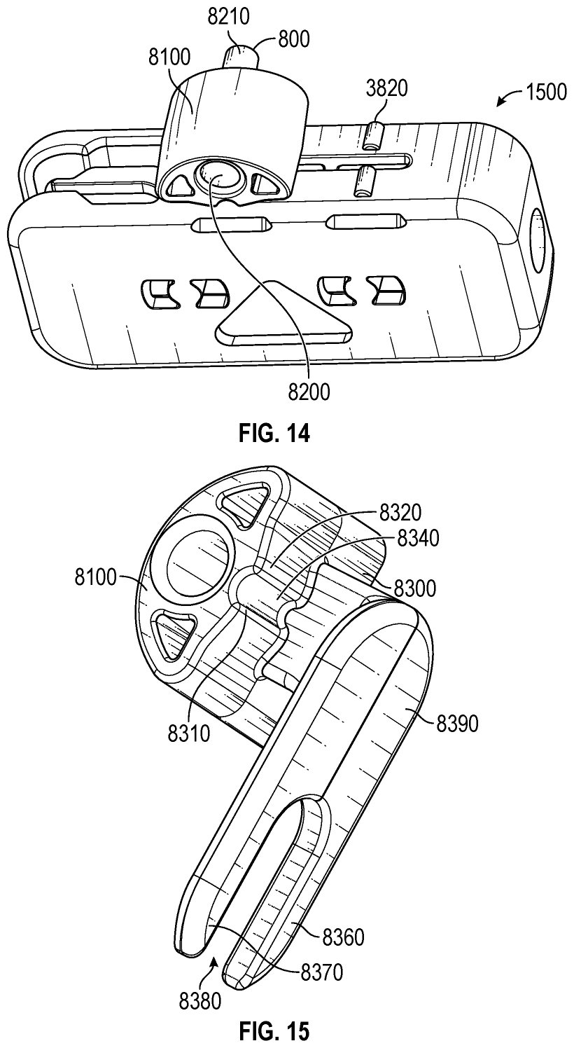

FIG. 14 shows a first perspective view of a quick release system according to another embodiment of the invention;

FIG. 15 shows a perspective view of a sliding lock used in a locking mechanism according to another embodiment of the invention;

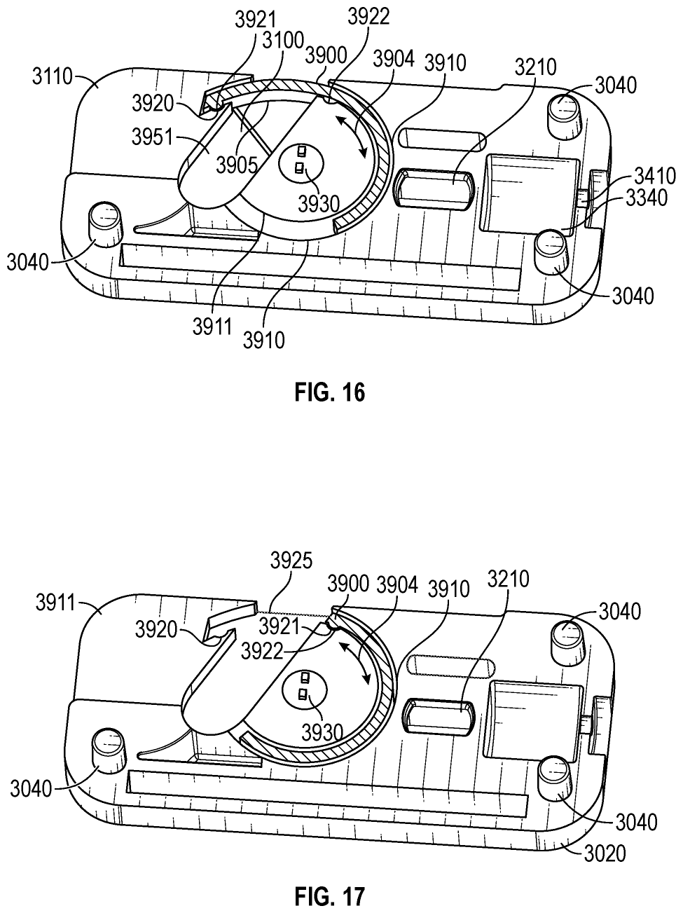

FIG. 16 shows a first side of the inside of a quick release system according to another embodiment of the invention;

FIG. 17 shows a second side of the inside of a quick release system according to another embodiment of the invention;

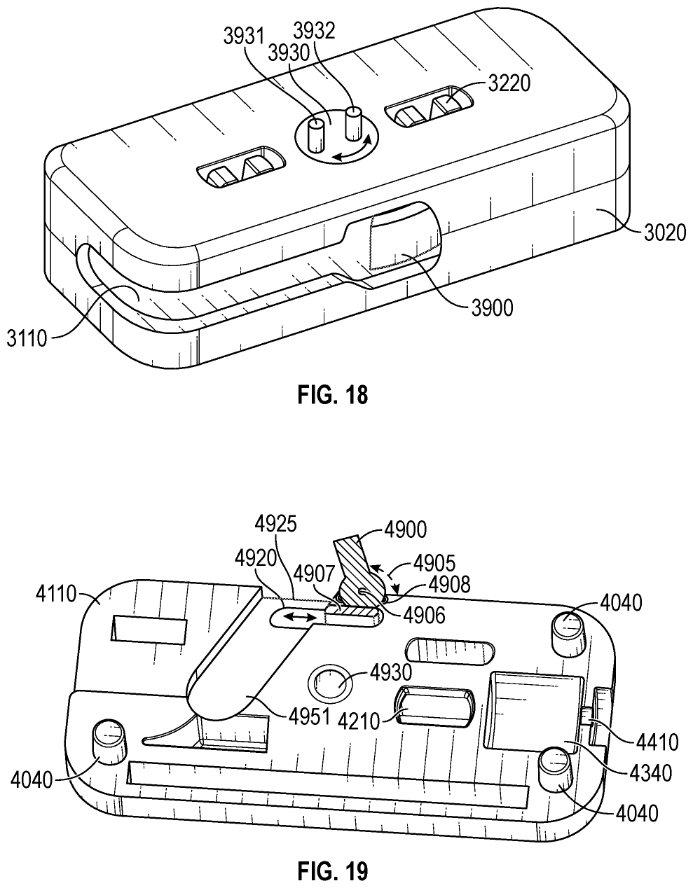

FIG. 18 shows a perspective view of a quick release system according to another embodiment of the invention;

FIG. 19 shows a side of the inside of a quick release system according to another embodiment of the invention;

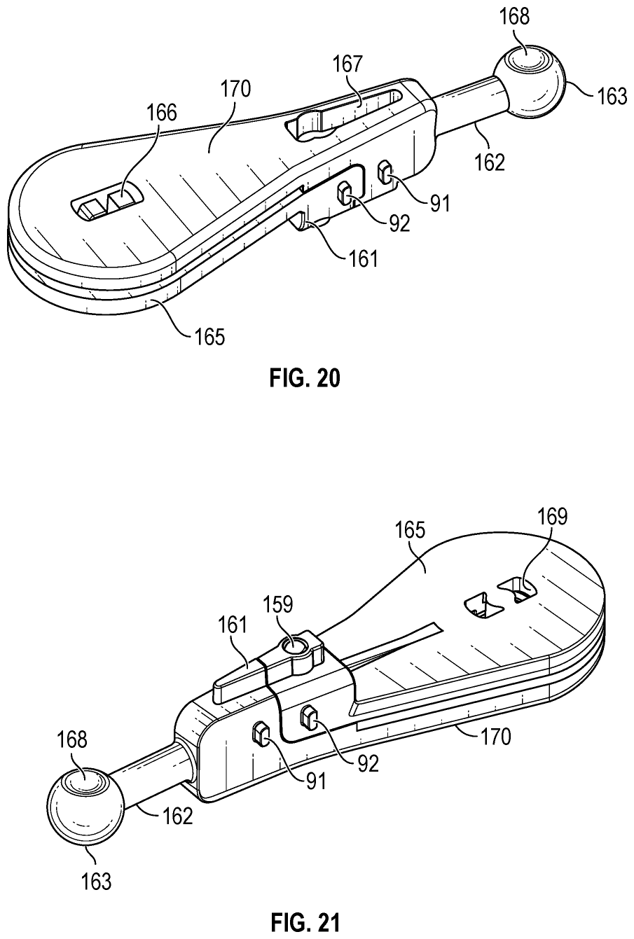

FIG. 20 shows a perspective view of a curtain attachment;

FIG. 21 shows another perspective view of a curtain attachment;

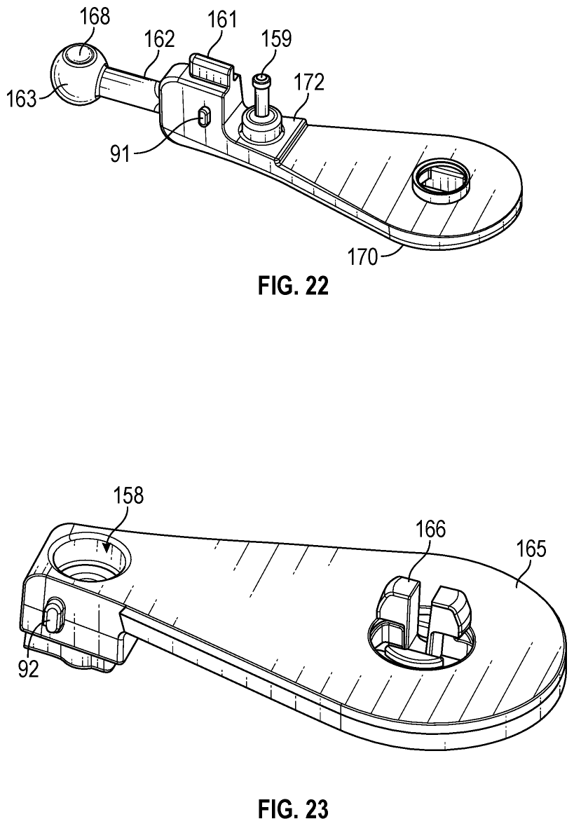

FIG. 22 shows a component of a curtain attachment;

FIG. 23 shows another component of a curtain attachment;

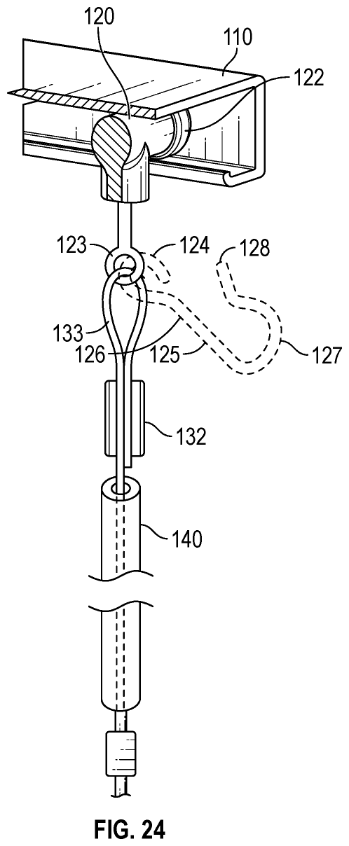

FIG. 24 shows an embodiment of attaching a roller to an extension;

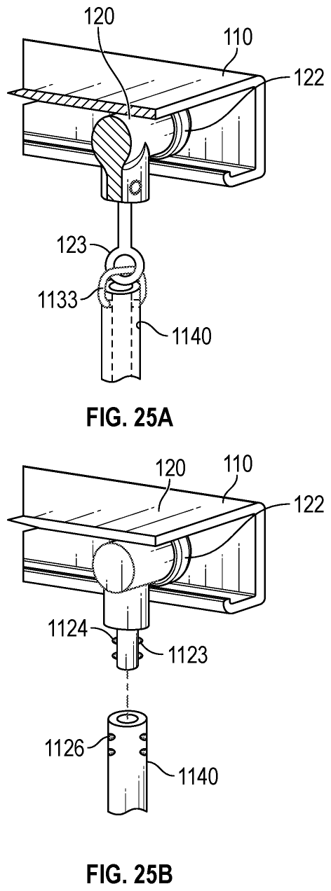

FIG. 25a shows another embodiment of attaching a roller to an extension;

FIG. 25b shows still another embodiment of attaching a roller to an extension;

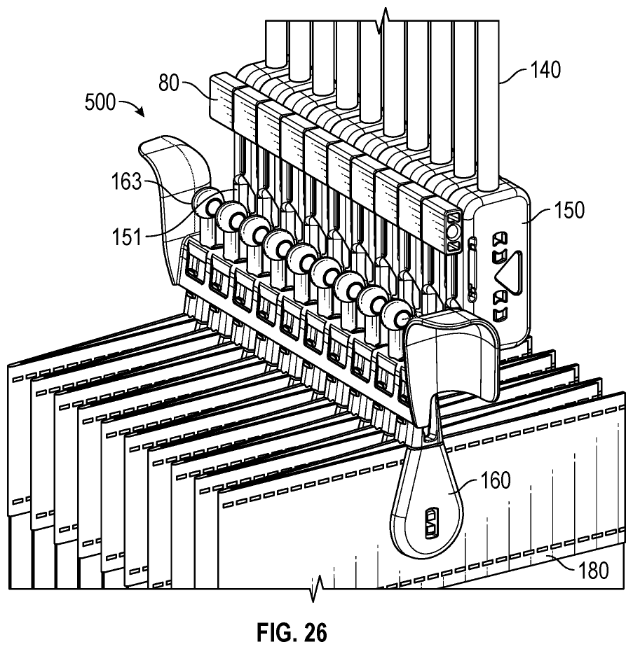

FIG. 26 shows a holder for the curtain attachments in operation; and

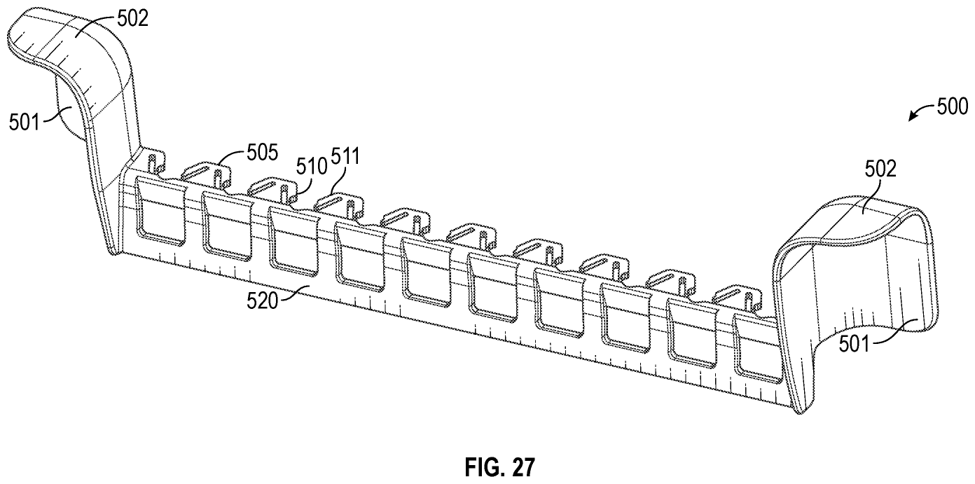

FIG. 27 shows the holder.

### DETAILED DESCRIPTION

Disclosed are various embodiments of the inventions. Referring to FIG. 1 is a disposable curtain system 100. The disposable curtain system 100 is attached to the ceiling by a track 110. The track may be attached directly to the ceiling or hang from the ceiling on extensions. Running through the track 110 are roller hooks or rollers with attachments 120. The roller hooks or rollers with attachments 120 have a hook 125 on the end thereof for attaching an extension or elongate member 140. So that the extension does not come off the hook 125, a cover 130 for the hook 125 is provided.

The extension 140 may be telescoping poles, poles that may be discreet sizes and interchanged depending on size needed, straps which may include a buckle that may be adjusted for size or the strap may be cut, a string, cable or wire that may be adjusted or cut. Since the extension will remain in place it is important that is easily cleanable for infectious diseases with an extension pole that has disinfectant. The material of the extension should not absorb liquids but should be made from a nonabsorbent plastic such as polyvinyl, acrylic, polyacrylic, nylon, carbon composite, PVC, polyethylene or the like.

The curtain 180 comes in discreet sections, such as 6-12 feet and most commonly 9 feet. The curtain discreet sections of 9-12 feet may be snapped together with snaps so as to make longer curtains. The curtains are made from disposable recyclable material such as polypropylene. The curtains 180 may be attached to the extension 140 with a quick-release mechanism 150 and a curtain attachment assembly or curtain attachment 160. The curtain attachment has a locking mechanism 80. The curtain attachment 160 during shipping and the initial assembly may be held together with a zip-tie, twist tie 90 or a holder such as 500 shown in FIGS. 26 and 27. Optionally, a second curtain or mesh 181 may be used with the extension and attached to the hood attachment or by other means.

Referring to FIG. 2, a track 110 is shown. The track is bolted, screwed, glued or otherwise attached to the ceiling. The track may also be on a hanging system and hang from the ceiling. The track 110 has an end piece (not shown) with snap connectors for the end piece. Running inside the track are roller hooks or rollers with attachments 120 having rollers 122. Additionally, other types of arrangements other than rollers 120 may be used so long as the slide easily along the track guides 118 such as slides, balls, or the like. Extending from the rollers are an eyelet 123 to which the eyelet of the hook 124 is attached. Other arrangements may be envisioned such as chains and other extenders for the roller hook. Over each hook, a covering 130 is affixed for quickly attaching the attachment 130 to the hook 125. FIG. 2 shows a quick-release 150, locking mechanism 80 and curtain attachment 160 all for attaching the disposable curtains 180. Rather than hook attachments, alternative embodiments may be used for attaching the extension 140 to the rollers 120 such as shown in FIGS. 24, 25 and 25a.

Referring to FIG. 3 is the quick-release curtain attachment 149 having a body 150 and a locking mechanism 80. The curtain attachment 160 has an alignment member 161 for alignment with other curtain attachments 160. An advantage of the curtain attachments 160 is that they can align and be held together using the alignment members 161 which insert in a receiving member (not shown see 167 in FIG. 20). In this manner all the curtain holders 160 may be simultaneously inserted into the channels 151 as shown in FIGS. 10 and 11. The curtain holders, extension holder and hook attachment are all made using injection molded parts using materials such as thermoplastic or thermosetting polymers, elastomers or metals. Common polymers like epoxy and phenolic are examples of thermosetting plastics which nylon, polyethylene and polystyrene are thermoplastic

Referring to FIGS. 4-7 is a hook attachment system or hook attachment 130. The hook attachment 130 includes a top side 251 and a lower side 252. A nob 210 is used for attaching a curtain proximate the hook 125. The hook attachment 130 includes a hinge assembly 238, 237. The lower side 252 has a hole 225 and stepped portion 202 for receiving the extension 140. On opening 229 is shown for movement of a snap fit or latch 226 (See FIG. 5) for attachment to a ledge 260.

FIGS. 6 and 7 show the inside of a first side and second side of the hook attachment system or hook attachment 130. The latch 228 has a face 227. Receiving holes 223 are show for receiving pegs or alignment devices 221. A cavity 232 may be used for receiving a swaged attachment such as shown at 132 in FIG. 132. The cable 133 may be inserted through the channel 217. A hook 125 may be inserted through the semi-circular channel 206. The channel is designed such that the hook 125 may have a wide range of freedom of movement of β also the distance β serves the purpose that the hook attachment 130 may be useable with various sizes of hooks. Not all roller hooks 125 are of the same dimensions, thus compensation needs to be made for wide and narrow hooks 125. Shown are hinge pegs 236 on hinges 238, which are inserted into holes 235 in FIG. 7.

FIGS. 8-11 shows the quick release and locking mechanism 149 having a body 150 for holding the head 163 of the curtain attachment. Referring to FIG. 8, the quick release body 150 has an upper side 300 and a lower side 302. The lower side has a slot 311 for receiving the neck (See 162 in FIGS. 20 and 21) of the curtain attachment. Openings 321 are shown which allow flexibility of the arms 322 (see FIG. 11). A cavity 325 is shown which matches protrusion 320 so that the quick release and locking mechanisms may match when in an array as shown in FIGS. 1 and 2. The locking mechanism 80 (see FIGS. 12 and 13) slides in a first sliding slot 380. Nibs 381 and 382 engage the catch 381. The handle 810 of the locking mechanism 80 assists in sliding the lock up and down. On the side of the handle 810 is a female opening 820 for receiving a male protrusion 821.

FIG. 9 shows the opposite side of the quick release locking mechanism shown in FIG. 8. On this side can be seen the male protrusions 821 on the handle 810 of the locking mechanism 80. Also, can be seen the protrusions 320. Arms 322 may be seen inside cavities which lock the two pieces together. The quick release locking mechanism may be made injection molding, machining or other manufacturing technics.

FIG. 10 shows a first side and an inside of a first side of the quick release and locking mechanism 149. Shown are the nibs 381 and 382 in the first sliding slot 380 for receiving the catch 831. The catch 831 slides along the first sliding slot 380. A second sliding slot 385 is also shown for receiving the forks 837, 836 of the locking mechanism 80. When the head 163 is in place at the base of the opening 310, the forks 837 and 836 may be slid into place. As the forks 837, 836 slide toward the neck receiving slot 311, the head 163 is locked into place. As the forks 837, 836 are moved away from the neck receiving slot 311 the head 163 may be removed. 151 shows the channel for receiving neck receiving opening 311, the head 163 can be removed. The channel opening or channel 151 is located on the side, front or back of the housing 150 so that when the head 163 is inserted it may be held in place by gravity. Cavity 319a is in place for receiving a magnet (not shown). The magnet assists in holding the array of quick release and locking mechanisms 149, 150 in place as shown in FIGS. 1 and 2. 321 shows an opening for locking arms 322 to hold a first side of the quick release body 150 to a second side of the quick release body 150. Alignment posts 304 assist in aligning the first side and second side of the body 150 together. 341 shows a channel for receiving a cable 133. Cavity 340 holds a swagged end of the cable in place.

FIG. 11 shows the second side of the body 150 of the quick release and locking mechanism 149. Shown are receiving openings 309 for receiving the alignment posts 304 for alignment of both sides of the body 150. The arms 322 for locking the two sides together are flexible so that the pieces may be snapped into place. This is so that the pieces may readily be assembled and disassembled for insertion and removal of the cable in channel 341 and swaged piece in 340. The arms 322 have a head with a catch 323. The arms 322 have a narrow section 324 for flexibility.

FIGS. 12 and 13 show the locking mechanism 80. The locking mechanism has a forked base 835 with tines 836 and 837. The tines 836 and 837 having a curved end and are spaced apart. The base 835 and tines 836, 837 slide through the second sliding slot 385. The tines are spaced apart a distance 383 from each other. The spacing 838 is so that the neck 162 can have a greater degree of movement when installed. In the first sliding slot the catch 831 may slide through. The catch 831 is slotted at 833 and has a top and bottom part 832 so that it may flex when engaging the nibs 382 and 381. Alternatively, the catch may be solid for a firmer grip. The base 835 has a holder 830 for the handle 810 of the locking mechanism. The handle 810 has a lower face 808 and an upper face 809 so that it may be gripped by fingers. The base 835 has a lower face 839.

Referring to FIGS. 14 and 15 is shown an alternative embodiment of the quick release and locking mechanism 800. In this embodiment only one sliding slot is used and the nibs 3820 are on the outside of the body 1500. The handle 8100 is curved. The handle has a catch 8340 which bumps 8310 and 8320. The base 8390 has a holder 8300 for the handle and times 8370 and 8360 with a gap 8380 for locking a head 163 in place.

FIGS. 16 through 18 show an alternative embodiment of the quick release and locking mechanism. In this embodiment the locking mechanism slide in a rotary fashion. The lock 3900 rotates 3904 within a housing 3910. The lock 3900 has an inside edge 3905 that slides/rotates along edge 3911. The lock 3900 is attached to a center piece 3930 which rotates by movement of the pins 3931 and 3932 which insert into corresponding holes (not shown) on the opposite side. When the quick release and locking mechanisms are all together in an array, they can be rotated all at once. The end of the lock 3900 has a nib 3921 that engages with a slot 3920. The neck 162 of the curtain attachment moves through the slot 3110. The head 163 is held in the slot 3951. Alignment posts 3040 may be inserted into corresponding holes/openings. Opening 3210 is used to receive arms to lock the two sides of the body together. The cable is received through the opening 3410 and swagged portion in the cavity 3340.

FIG. 16 shows the lock 3900 in a locked position and FIG. 17 shows the lock 3900 in an open position. Nib 3921 engages catch 3922. Arms 3220 extend for engagement with slot 3210.

FIG. 19 shows another embodiment of the invention. In this embodiment, the lock is engaged with a switch 4900. The switch moves from locked to unlocked and vice versa by rotation 4905 of the switch 4900. The switch has a center point of rotation or pin 4906. The switch moves a slide 4907 through a slot 4920 in the channel 4925. The neck 162 of the curtain attachment moves through the slot 4110 and head 163 moves through the channel 4925. When the head 163 rests in the channel bottom 4951 it may be locked into place. The center has a magnet 4930. Alignment posts 4040 are used and cable receiver 4410 is also used.

With reference to FIGS. 20 through 23, a curtain attachment 160 is shown. The curtain attachment has a first piece 170 and a second piece 165. The first piece 170 has a head 163 with a flat part 168 and a neck 162. The flat part 168 of the head 163 is for guiding the head into the channel 151 in order to allow adequate clearance. The first piece 170 and second piece may be attached together with arms 166 and locking head 159. The locking head 159 goes into opening 158 to snap into place. Other forms of attachment may also be used such as adhesive, melting of plastic, etc. The curtain attachments 160 also include a guiding slot 167 and a protrusion 161 for alignment when the curtains an in an array. Projections 91 and 92 are to assist in aligning a twist wire (see FIG. 1) or an alignment tool 500 in FIGS. 25 and 26.

In addition to the above embodiments, it is envisioned that other types of sliding locking mechanism may be made. Sliding not only includes linear sliding, but also rotary sliding of parts.

With respect to FIG. 24, an extension 140 is shown which may be attached by cable 133 having a swagging 132 directly to the eyelet 123 of the hook 125. The rollers 122 are located on a first end of the roller 120 and the eyelet or attachment 123 is located on the second end of the attachment. The cable 133 defines a hole or opening when closed off by the swagging 132. The hook 125 has a shank 126, a bend 127 and a point 128. The area between the shank 126 and the point is the gap 129. In this manner, the hook attachment 130 may be eliminated, or be used for other purposes such as attaching an upper mesh curtain.

In an alternate embodiment shown in FIG. 25, the hook attachment 130 is also eliminated. This is very important, because in current systems, a loop such as 1133 in FIG. 25A must be inserted on the hook and the hook 125 needs to be crimped. Such repetitive motion is difficult on an installer. An extension 1140 is shown. the extension has a hole, opening or bore on a first end (where 1133 goes through) and quick release 150 on a second end. See FIGS. 1-3. The extension 1140 may be any relatively stiff or rigid rod made of nylon, acrylic or other polymer or composite material. A wheel system 120 is shown which has wheels 122 on a first end and an attachment device or first attachment 123 on a second end which may be integral or extending as a separate part such as a clip, clasp, chain link, catch, snap, hook, safety pin, buckle metal loop, shackle, eyelet, grommet, carabiner, spring hook or any other attachment means having a hole, opening or bore integral with or extending from the wheel system 120 for connecting the roller 122 to the extension. The hole, opening or bore 123 is integral and may be rigidly attached to the wheel system 120. The extension 140, 1140 may have holes, openings or bores therethrough for holding a corresponding attachment device 1133 such as a loop clip, clasp, chain link, catch, snap, hook, safety pin, buckle metal loop, shackle, eyelet, grommet, carabiner, spring hook or any other attachment or means, said corresponding attachment device 1133 having a hole, opening or bore for attachment through the hole, opening or bore of attachment device or first attachment 123. In addition, it is envisioned that the attachment device 123 may be eliminated and replaced by a nipple, nib or other type of pipelike connector such as a thread, snap and the like 1123. The connector 1123 may be secured by glue, epoxy or the like. The connector 1123 may also include barbs or protrusions 1123 which may engage with openings 1126 on the extension 1140. The advantage of such a system is that when hanging, there is not need for a hook attachment 130 or any other device to attach to a hook. It does not require an assembler to assemble the hook attachment 130 while standing on a ladder and is much faster for the assembler. The wheel system 120 can come preassembled so that an individual hanging the system 120 only needs to remove the old wheel system and replace the wheels with the preassembled units. The first attachment and corresponding attachment cannot be hooks or other device that is not closed because the extension would tend to slip off the wheels due to pulling forces on the curtains.

A method for attaching a disposable curtain system 100 comprising: providing a track 110; preassembling a wheel system 120 together with an extension 140, 1140 having a curtain quick-release system 150, said wheel system 120 having: a first end with rollers 120 for use with a track 110; and a second end with an attachment 123, said attachment having a first hole, opening or bore therein; said extension 140, 1140, attached to the wheel system 120, said extension 140, 1140 having: a first end with the quick release system 150 for a curtain 180 attached thereto; and a second end with corresponding hole, opening or bore therein and a corresponding attachment 1133 for going through the first hole, opening or bore in the attachment, wherein said corresponding attachment 1133 is a closed hole, opening or bore; inserting the pre-assembled wheel system 120 onto the track 110; and attaching the curtain 180 using a curtain attachment 160 to the quick-release system 150.

FIGS. 26 and 27 show a retainer or guide for holding the curtain attachments together and for guiding them into the quick-release. FIG. 26 shows the retainer or guide 500 for holding the curtain holders 160 so the that the head 163 may be directed into the channel 151 prior to locking mechanism 80 being slid into place for locking the heads 163 into the quick release 150. FIG. 27 shows the quick release 150. Each end of the quick release 500 includes a thumb holder 502. A user's thumbs may engage with the holder at 501 to slide the curtain holders 160 into the quick release 150. Each retainer or guide has holders 505 with barbs 510 and 511 for holding the neck 162 of the curtain holder 160. The retainer can have between 5 to 15 holders, most desirably between 8 to 12 holders.

Referring to FIGS. 1 and 26 a method for attaching a disposable curtain system 100 is disclosed providing a hook and/or roller attachment 130, 1133, 1123; providing an extension 140, operatively attached to the hook and/or roller attachment 130, 1133, 1123; providing a quick-release 150, having an extension attachment operatively attached to the extension; attaching a curtain attachment 160 of the quick-release 150 to the curtain 180, wherein at least one of the curtain attachment 160 and the extension attachment has a neck 162 and a head 163 and the other of the curtain attachment and the extension attachment has at least one of a cradle or receiver 310 for receiving the head 163; inserting the head 163 into an opening in the second portion 151 of the quick-release and allowing the head to drop into the cradle or receiver 310; and locking the head within the at least one of a cradle or receiver 310, wherein a locking mechanism 80 is configured to move to at least partially cover the opening 151 of the at least one of a cradle or receiver.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

What is claimed is:

1. A curtain attachment system comprising:
a wheel system, said wheel system having:
a first end with rollers for use with a track; and
a second end with a first attachment or portion having a first hole, opening or bore therein;
a curtain quick release;
an extension, said extension having:
first end attached to the curtain quick release system; and
a second end with a hole, opening or bore therein corresponding to said first hole, opening or bore.

2. The curtain system of claim 1 wherein the first attachment is one of a clip, clasp, chain link, catch, snap, hook, safety pin, buckle metal loop, shackle, eyelet, grommet, carabiner or spring hook.

3. The curtain system of claim 1 further comprising a corresponding attachment, said corresponding attachment is one of a clip, clasp, chain link, catch, snap, hook, safety pin, buckle metal loop, shackle, eyelet, grommet, carabiner or spring hook.

4. The curtain system of claim 1 wherein the extension is a rod made of one of nylon, acrylic or other polymer.

5. The curtain system of claim 1, wherein neither one of the first attachment and corresponding attachment is a hook.

6. The curtain system of claim 1, wherein the curtain system, quick-release system and extension are pre-assembled prior to installation on the track.

7. The curtain system of claim 2, wherein the curtain system, quick-release system and extension are pre-assembled prior to installation on the track.

8. The curtain system of claim 3, wherein the curtain system, quick-release system and extension are pre-assembled prior to installation on the track.

9. The curtain system of claim 4, wherein the curtain system, quick-release system and extension are pre-assembled prior to installation on the track.

10. The curtain system of claim 5, wherein the curtain system, quick-release system and extension are pre-assembled prior to installation on the track.

11. A method for attaching a disposable curtain system comprising:
providing a track;
preassembling a wheel system together with an extension having a curtain quick-release system, said wheel system having: a first end with rollers for use with a track; and a second end with an attachment, said attachment having a first hole, opening or bore therein; said extension, attached to the wheel system, said extension having: first end with the quick release for a curtain attached thereto; and a second end with corresponding hole, opening or bore therein and a corresponding attachment for going through the first hole, opening or bore in the attachment, wherein said corresponding attachment is a closed hole, opening or bore;
inserting the pre-assembled wheel system onto the track; and
attaching the curtain using a curtain attachment to the quick-release system.

12. A curtain retainer system for use with a curtain having a plurality of curtain attachments extending from the curtain, said curtain attachments each having a neck and a head, wherein said curtain attachments are for attachment to a curtain quick-release system, said curtain retainer comprising:
a plurality of grips; and
a plurality of holders, wherein each holder for engaging and holding the necks of the curtain attachments while the curtain attachments are inserted into the curtain quick release.

13. The curtain retainer system of claim 12, wherein each holder has a plurality of barbs for retaining the necks.

14. The curtain retainer of claim 12, wherein the plurality of grips are shaped for insertion of a thumb.
